(19) United States
(12) Patent Application Publication
(10) Pub. No.: US 2015/0239285 A1
(43) Pub. Date: Aug. 27, 2015

(54) Reversible Interchangeable Art Images

(71) Applicant: Barbara Day Romero, Santa Fee, NM (US)

(72) Inventor: Barbara Day Romero, Santa Fee, NM (US)

(21) Appl. No.: 14/301,570

(22) Filed: Jun. 11, 2014

Related U.S. Application Data
(60) Provisional application No. 61/943,266, filed on Feb. 21, 2014.

(51) Int. Cl. B44F 7/00; B44C 3/02; B44C 1/28

(52) U.S. Cl. CPC B44F 7/00; B44C 1/28; B44C 3/025

(57) ABSTRACT

An art kit providing a method for making a metal three-dimensional wall sculpture comprising; a vertical hanging background panel mounted on the top surface with a magnet attracting metal sheet, a plurality of three-dimensional shapes displaying artistic images, the inner sides and edges of the shapes encasing magnets, allowing the shapes to attach to the panel. A plurality of smaller three-dimensional shapes, magnet encased, without images, used to stack the larger shapes. The three-dimensional shapes can be moved around on the panel, rearranged, stacked, reversed, and interchanged, creating new design variations.

### CROSS-REFERENCE TO RELATED APPLICATIONS

This application claims benefit of provisional patent application No. 61/943,266 filed Feb. 21, 2014

### BACKGROUND

The embodiments of Reversible Interchangeable Art Images relate to art and the art industry. An art kit, Reversible Interchangeable Art Images, provides the user with the means for creating a distinctive metal three-dimensional wall sculpture. The opportunity to create art, to enhance the aesthetic quality of the environment in a home or a work place is the purpose of the invention.

Historically, the components of metal wall sculpture have been welded together, thus resulting in a permanent artistic structure. A less common method uses epoxy, again resulting in permanence. Currently, there is no existing wall art kit that encases magnets inside component parts, thus allowing the magnet encased three-dimensional parts to be attached to a vertically hung metal background, the parts easily moved around, removed, stacked, reversed and interchanged.

### SUMMARY

Reversible Interchangeable Art Images is an art kit providing a method for the novice art enthusiast to create a unique, professional looking three-dimensional metal wall sculpture requiring minimal skills. The art kit comprises a vertically hung sheet metal support panel that attracts magnets, a plurality of magnet encased three-dimensional shapes that attach to the support panel, and smaller three-dimensional magnet encased shapes for stacking. The larger three-dimensional shapes each display a colorful image on two or more flat-faced sides. The three-dimensional shapes magnetically affix to the panel thus creating an artistic wall mounted work of art. The three-dimensional shapes are constructed with magnets of appropriate strength glued to one or more inner sides and one or more inner edges of the shape. The shapes can also be constructed by embedding magnets in a molded material. Typically, the shapes in the art kits weigh under one pound. The size and design of the three-dimensional shapes are not restricted by weight. Neodymium magnets and other types of stronger magnets can be used to accommodate heavier three-dimensional shapes required in a specific art kit of specific size and design. The magnets are not visible, not touchable. A young child cannot pull off or chew off a magnet, thus eliminating the danger of swallowing one. The outer perimeter of each three-dimensional shape can be square, round or a unique shape. The subject matter of the surface image is abstract, geometric, quasi-representational or realistic depending on the theme of the art kit. The images are hand painted, printed, photo-transferred, engraved or otherwise placed on the flat sides and/or edges of the shapes. Each shape has a top side and a reverse side displaying a different image. A broad edge or edges can additionally display an image. The art kit includes one or more identical shapes for each space on the support panel. Each designated space can accommodate, one at a time, a three-dimensional shape. A different design can be displayed by reversing a shape, affixing a shape on an edge or by interchanging it for another shape, thus the user can radically change the overall design.

A guide sheet instructs the user where to place each three-dimensional shape on the support panel in relation to the other shapes. The more advanced user can disregard the instructions and place or stack or layer the shapes in any desired arrangement creating a very personal, original design.

### BRIEF DESCRIPTION OF THE DRAWINGS

drawings are not to scale

FIG. 1a perspective view of support panel displaying three 3-D shapes with encased magnets

FIG. 1b perspective view of support panel displaying three 3-D shapes with encased magnets in reverse

FIG. 2 perspective view of 3-D shape with multiple-layered surfaces

FIG. 3 side view of support panel displaying 3-D shape jutting out

FIG. 4a perspective view of support panel displaying six 3-D magnet encased shapes arranged in order of mathematical permutation

FIG. 4b perspective view of support panel displaying six 3-D magnet encased shapes in reverse

FIG. 5a perspective view of 3-D shape with extended perimeters, magnet encased in smaller shape

FIG. 5b side view of 3-D shape with extended perimeters, magnet encased in smaller shape

FIG. 6 perspective view of 3-D stacking device with encased magnet

FIG. 7a perspective view of support panel displaying three stacked 3-D shapes, three stacking devices

FIG. 7b side view of support panel displaying three stacked 3-D shapes, encased magnets, stacking devices

FIG. 7c perspective view of 3-D shape with encased magnet, stacking device

FIG. 7d perspective view of 3-D shape with encased magnet, stacking device

FIG. 7e perspective view of 3-D shape with encased magnet, stacking device

FIG. 8a perspective view of support panel displaying two partial panels, stacking devices

FIG. 8b side view of support panel displaying two partial panels, stacking devices

FIG. 9 perspective view of support panel displaying a plurality of identical stick-like shapes, stacked

FIG. 10a perspective view of canvas covered stretcher bars enclosing metal support panel

FIG. 10b side view of canvas covered stretcher bars enclosing metal support panel

FIG. 11a side view of support panel displaying open frame with two magnet encased 3-D shapes, frame jutting out, three stacking devices

FIG. 11b perspective view of open frame with two magnet encased 3-D shapes attached to metal lining, three stacking devices

### DETAILED DESCRIPTION OF EMBODIMENTS AND DRAWINGS

The detailed description of the embodiments and drawings are meant to define and illustrate and not to limit the scope of the invention.

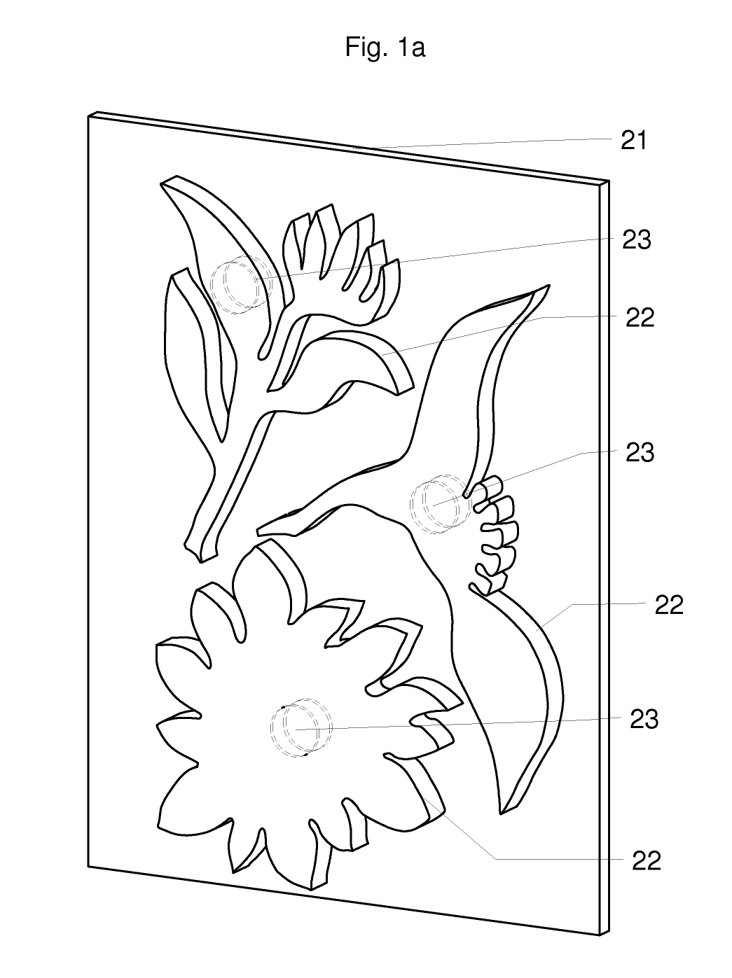

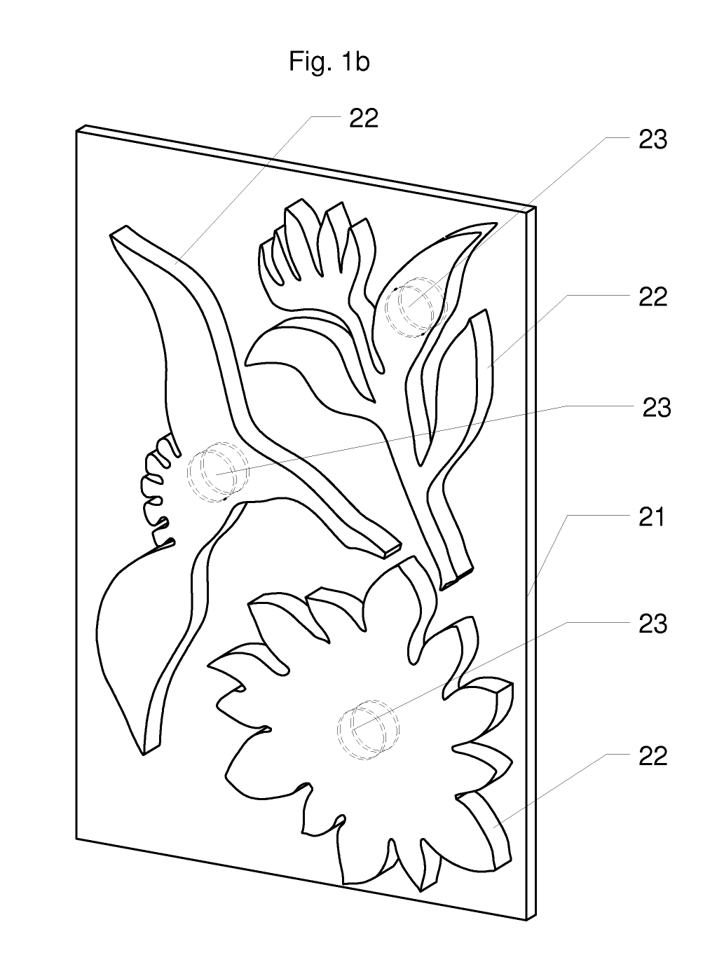

FIG. 1 a shows a support panel (21) comprising a thin sheet of magnet attracting metal backed with a sturdy, lightweight particle board of identical size. The metal sheet is adhered to the board using glue, epoxy or any other known means. The support panel hangs vertically, has proper hanging apparatus including hooks and wire adhered to said support panel using any known means. The shape of said support panel can be square, rectangular or a unique shape. Said support panel displays three 3-D shapes (22) with unique perimeters. The three 3-D shapes (22) display a flat-faced surface and an edge. The preferable materials for said 3-D shapes are sheet metal, sheet aluminum, sheet particle board or sheet plastic cut or stamped, then fabricated into the desired said 3-D shapes. Molded plastic or any other known molding material can be used to create said 3-D shapes, embedding the magnets into the molding material. Perimeters of shapes can be simple and softly rounded for easy handling by a child or intricately cut using laser, water jet, plasma or any other known cutting machinery. Ferrite or neodymium magnets (23) of appropriate strength are glued to or molded into the interior sides and/or interior edges of said 3-D shapes at strategic locations. The magnets (23) are encased inside said 3-D shapes, therefore not visible. Most often, but not exclusively, three said magnets are encased inside said 3-D shapes at the top side, the reverse side and an edge, allowing said 3-D shapes to be affixed to the support panel in multiple variations.

FIG. 1b shows three 3-D shapes (22) with encased magnets (23), reversed. The reversed 3-D shapes (22) display different images.

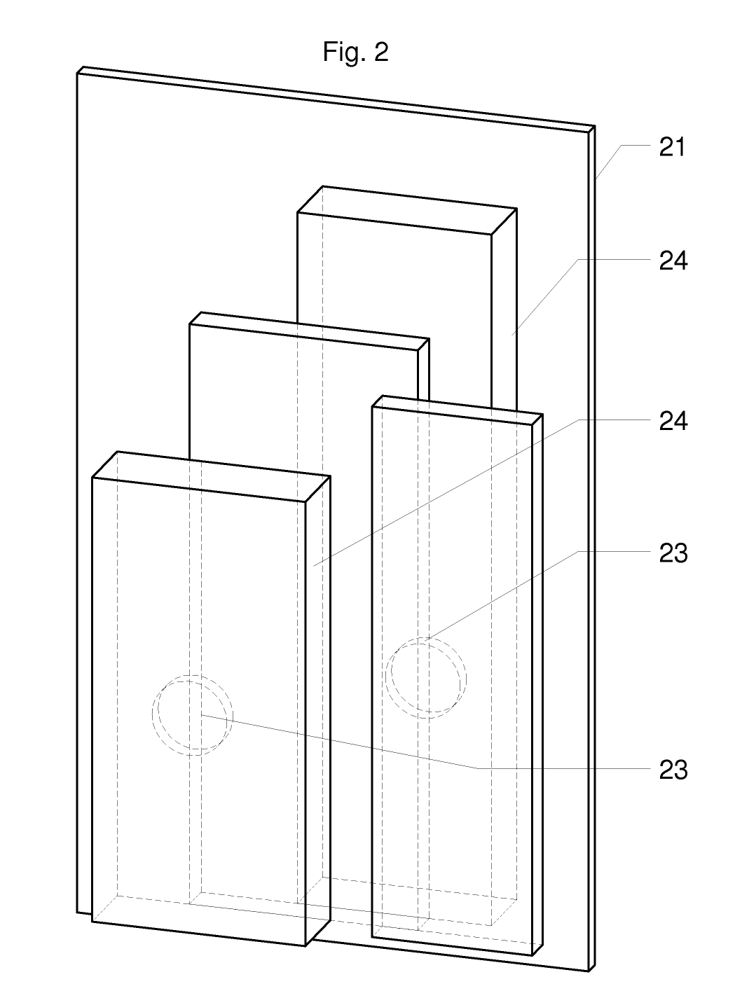

FIG. 2 shows a perspective view of a support panel (21) displaying one 3-D shape (24). The 3-D shape (24) comprises four rectangular shapes of variable depths fabricated or molded together as one shape. Magnets (23) are glued to the inner side of the most forward flat-faced surface of said 3-D shape and to the inner side of the most forward flat-faced surface of the reverse side of said 3-D shape.

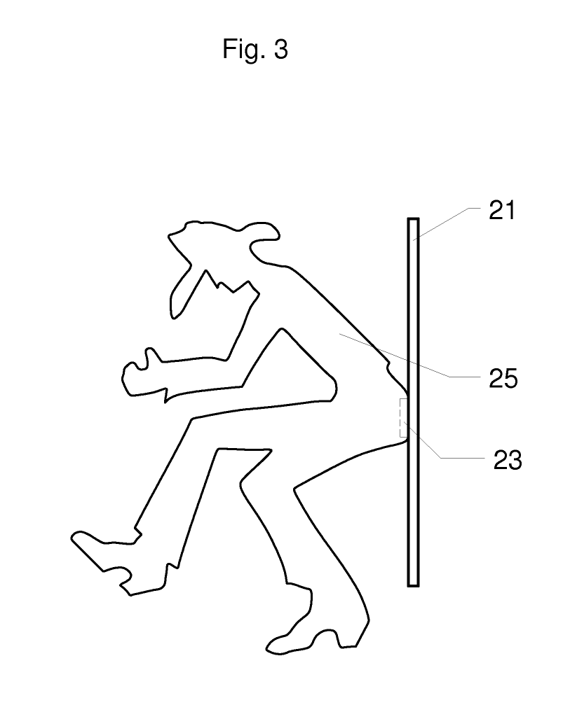

FIG. 3 shows a side view of a support panel (21) with one 3-D shape (25) positioned jutting out from an edge, the magnet (23) encased inside the edge. The jutting out position is unusual, the 3-D shape (25) appearing to defy gravity.

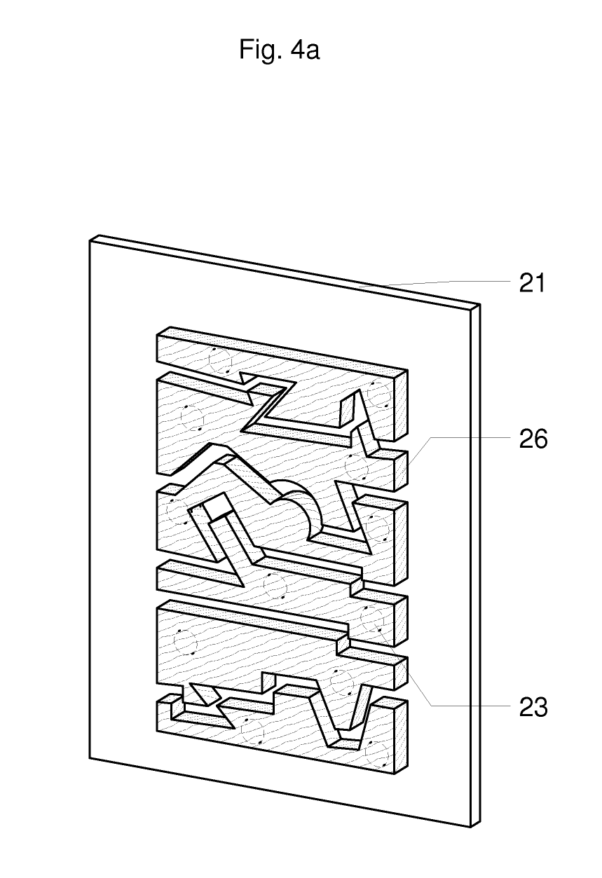

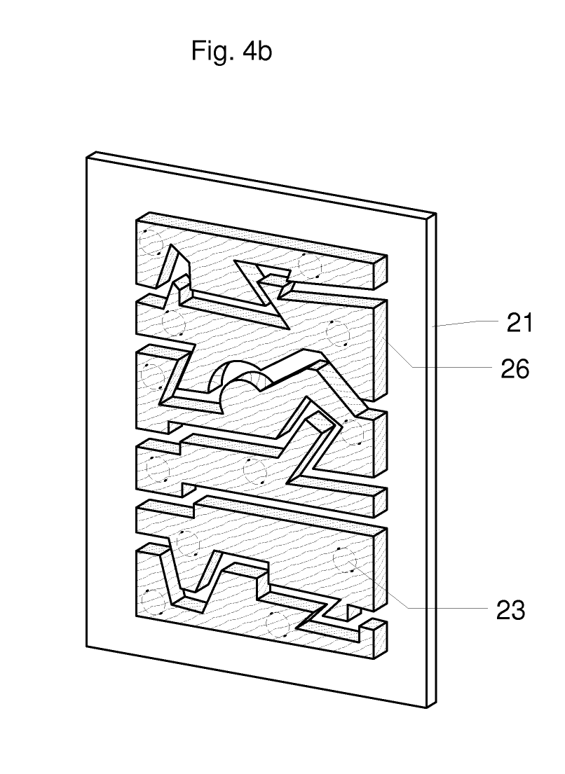

FIG. 4a shows a support panel (21) with six 3-D shapes (26) with encased magnets (23). The 3-D shapes (26) have perimeters, when placed adjacent to each other, match. The six said 3-D shapes are positioned on the support panel (21) allowing space between each said 3-D shape, thus creating depth. Each said 3-D shape has a different colorful image. The art kit includes two more identical six said 3-D shapes, totaling 18 shapes. Each of the additional said 3-D shapes displays a different colorful image on the top facing side. The additional 12 said 3-D shapes can only be placed in the designated spaces for the original six said 3-D shapes. The user can interchange one or two or three of the three identical said 3-D shapes in any arrangement, only within the corresponding placement on said support panel. Replacing only one of the six said 3-D shapes with an identical said 3-D shape changes the overall design. This placement method constitutes a mathematical permutation, making possible different design variations numbering in the thousands by changing only one said 3-D shape.

FIG. 4b shows six 3-D shapes (26), reversed. The six 3-D shapes (26) can be, as a whole, reversed. Each of the 18 reversed said 3-D shapes displays a different image.

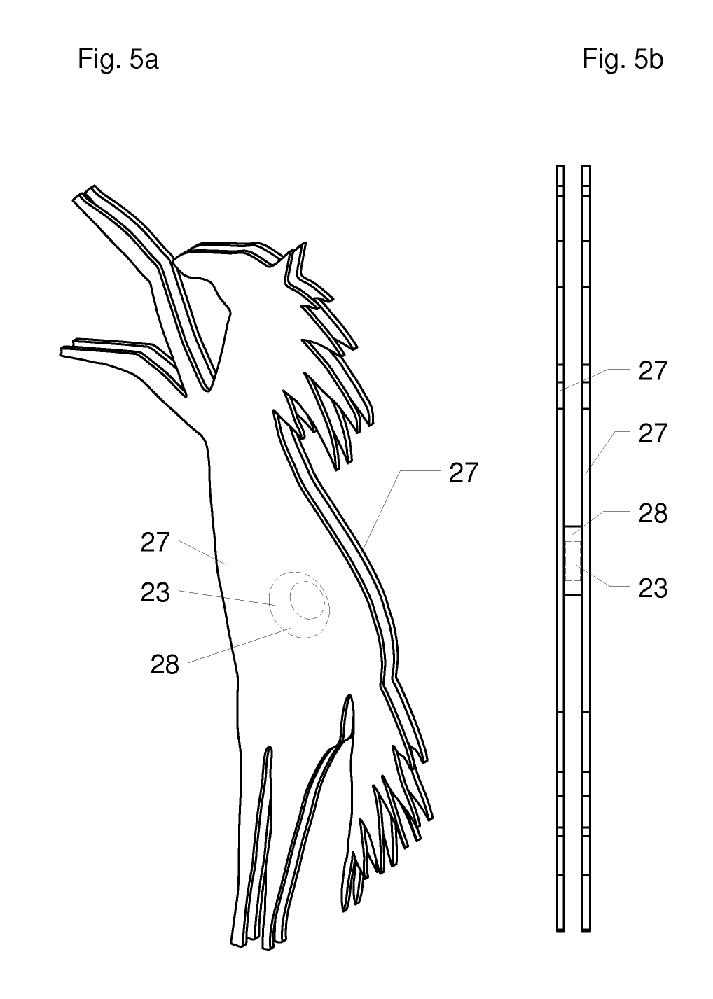

FIG. 5a shows a perspective view of two sides of a 3-D shape (27) with extended perimeters of the top and reverse flat-faced sides. The two flat-faced sides of the 3-D shape (27) are connected by sandwiching a smaller, circular 3-D shape (28) encasing a magnet (23). This method is preferable when the outer perimeter of said 3-D shape is intricate, making the fabrication of said 3-D shape less difficult.

FIG. 5b shows a side view of two sides of a 3-D shape (27) attached by a circular shape (28) encasing a magnet (23).

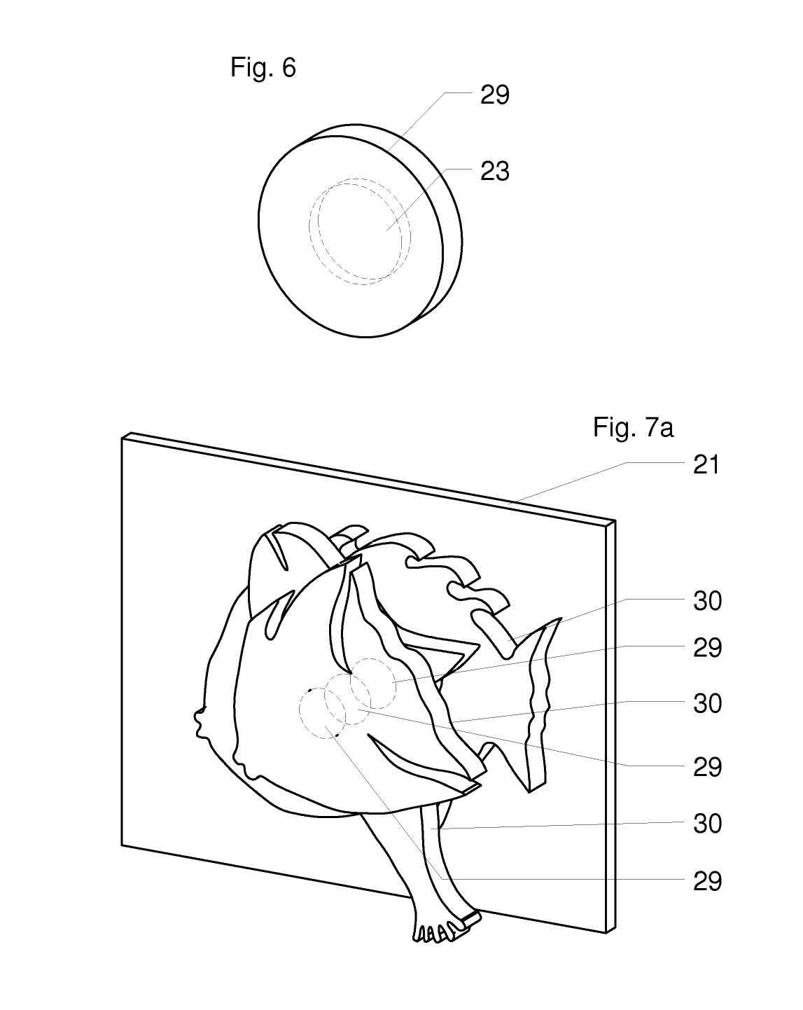

FIG. 6 shows a smaller 3-D shape (29) used to create dimension. The 3-D shape (29) does not display an image, has a function, namely to aide in stacking and layering the 3-D shapes (22,24,25 etc.) displaying images. Said 3-D shape is made of metal that attracts magnets, providing maximum adhesion strength.

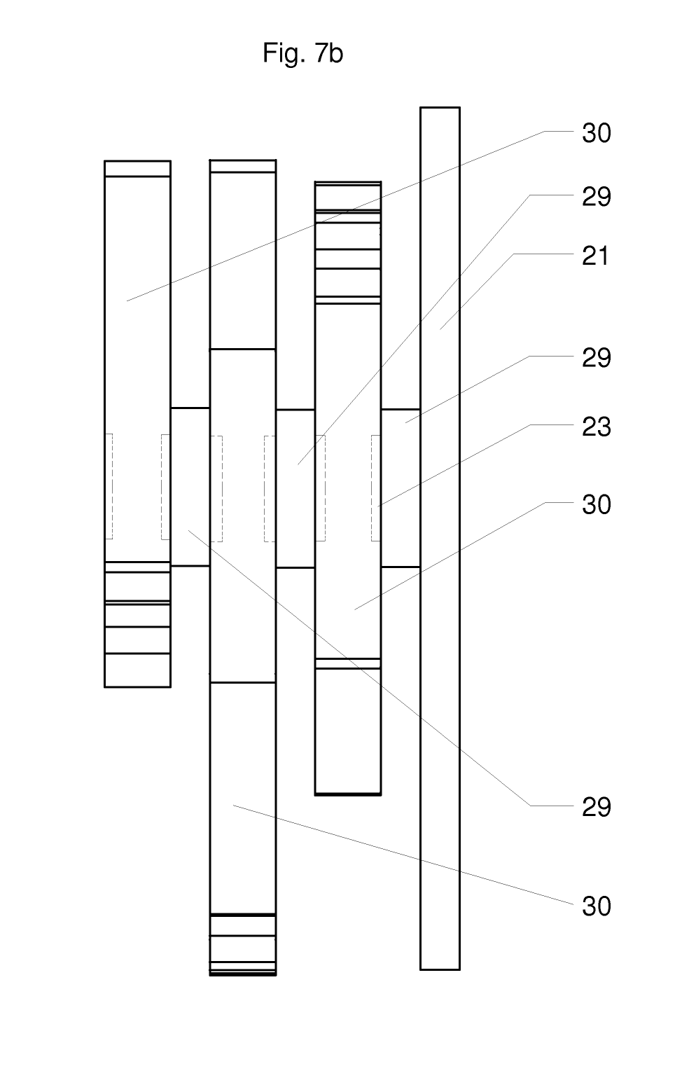

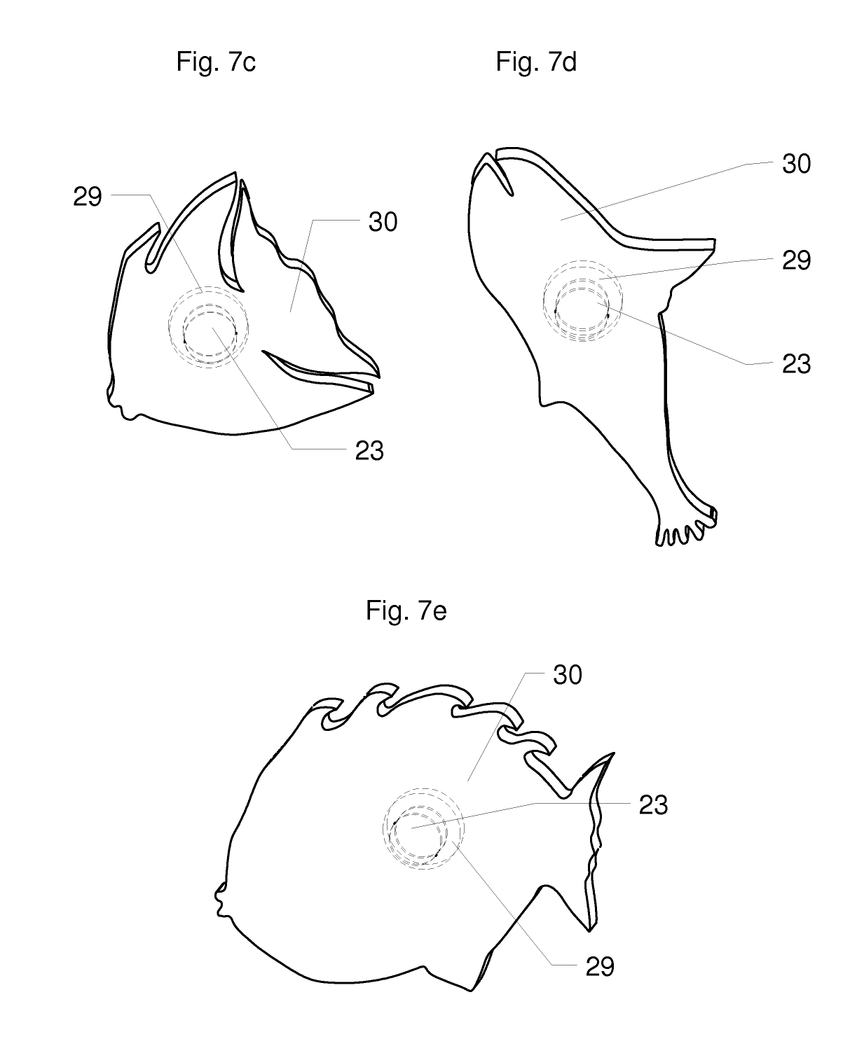

FIG. 7a shows a perspective view of a support panel (21) displaying three 3-D shapes (30) with encased magnets (23) stacked one on top of the other. The 3-D shapes (30)are separated using a stacking device (29), creating added dimension. Additionally, a stacking device (29) separates one of said 3-D shapes from the support panel (21).

FIG. 7b shows a side view of a support panel (21) displaying three stacked 3-D shapes (30) separated using three stacking devices (29) between each of the 3-D shapes (30) and the support panel (21). Encased magnets (23) affix to the stacking devices (29).

FIG. 7c shows a 3-D shape (30) with an encased magnet (23) and a stacking device (29) affixed to the bottom side.

FIG. 7d shows a 3-D shape (30) with an encased magnet (23) and a stacking device (29) affixed to the bottom side.

FIG. 7e shows a 3-D shape (30) with an encased magnet (23) and a stacking device (29) affixed to the bottom side.

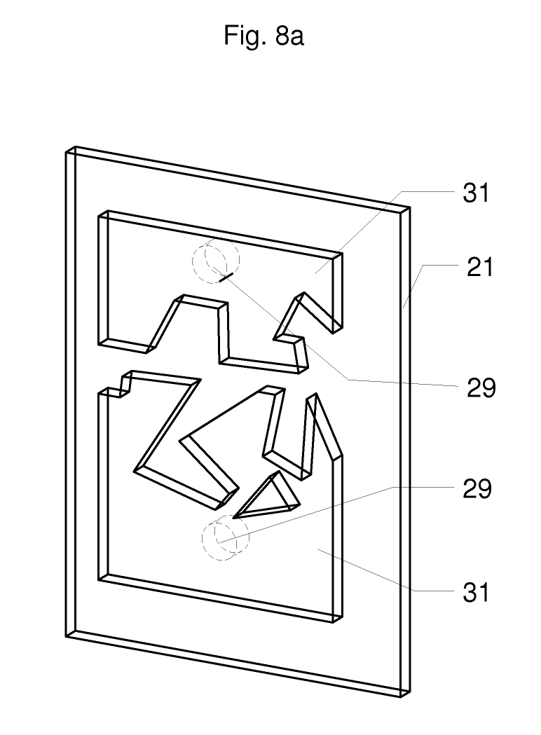

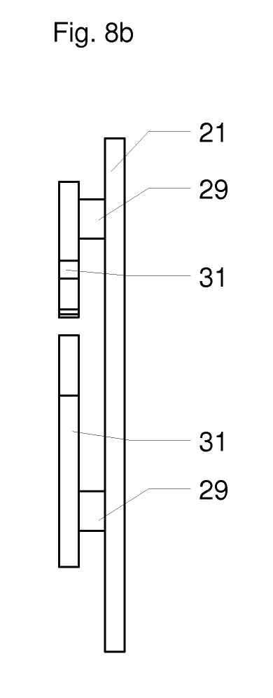

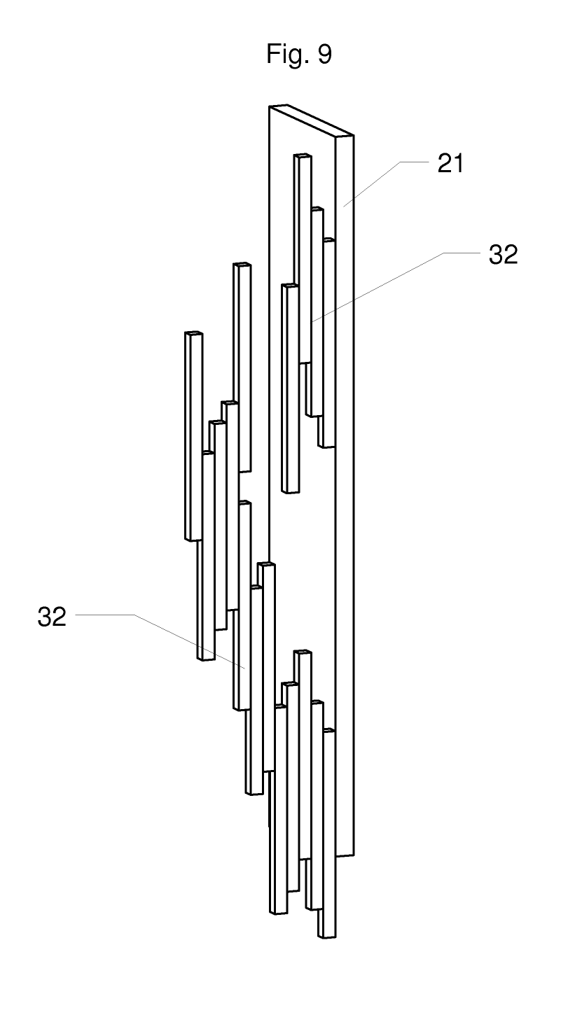

FIG. 8a shows a perspective view of two partial panels (31) positioned on a support panel (21). The partial panels (31) provide depth, can add two or more said partial panels, can stack said partial panels to create even more depth. Said partial panels can extend off the edges of the support panel (21), can display openings, can be substantially smaller than said support panel. Stacking devices (29) are used to separate said partial panels from said support panel and from other said partial panels. Said partial panels are made of sheet metal, sheet aluminum, sheet particle board or any other suitable material, without encased magnets, and are reversible. The perimeters of said partial panels are triangular, square, rectangular, circular, curved or jagged.

FIG. 8b shows a side view of a support panel (21) with two partial panels (31) affixed to the support panel (21) using stacking devices (29).

FIG. 9 shows a perspective view of a support panel (21) with a plurality of 3-D shapes (32) stacked in gravity defying placements. Up to 100 or more 3-D shapes (32) can be included in the kit. Said 3-D shapes are the size of a crayon or larger.

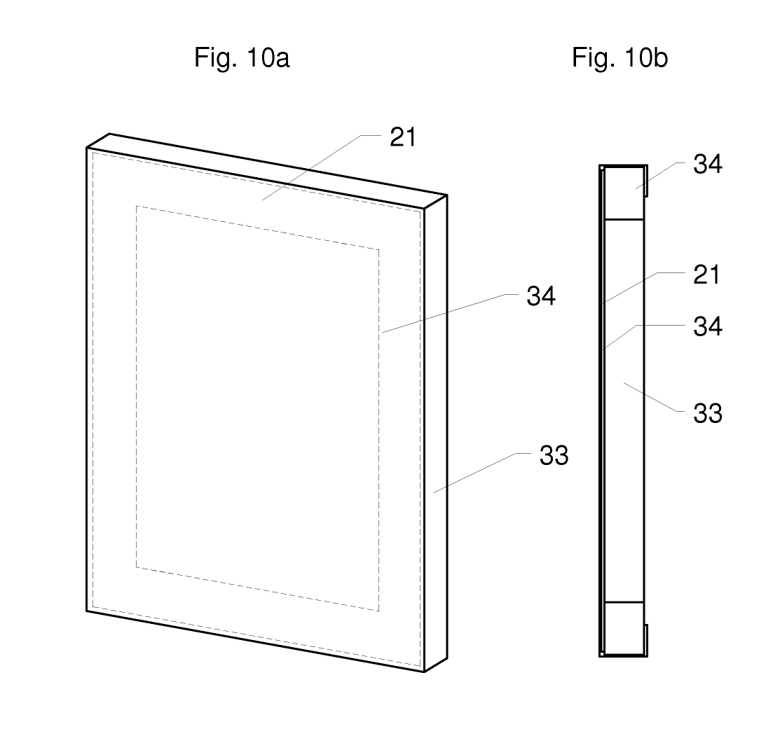

FIG. 10a shows a perspective view of a basic artist's canvas with a support panel (21) laid over wooden stretcher bars (33), framing the exact size of the support panel (21). Canvas (34) is laid over and wrapped around the sides and back portions of said support panel and the stretcher bars (33). The canvas (34) is stapled tightly to the back side of said stretcher bars. Said support panel now has the appearance of an artist's canvas.

FIG. 10b shows a side view of a support panel (21) placed over stretcher bars (33) of exact size, secured by canvas (34) tightly wrapped around the support panel (21) and the stretcher bars (33).

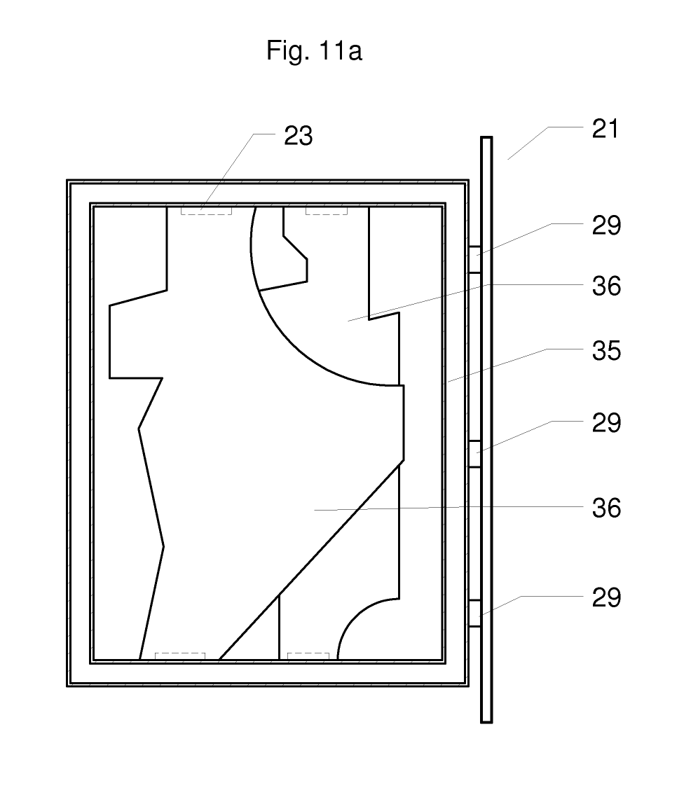

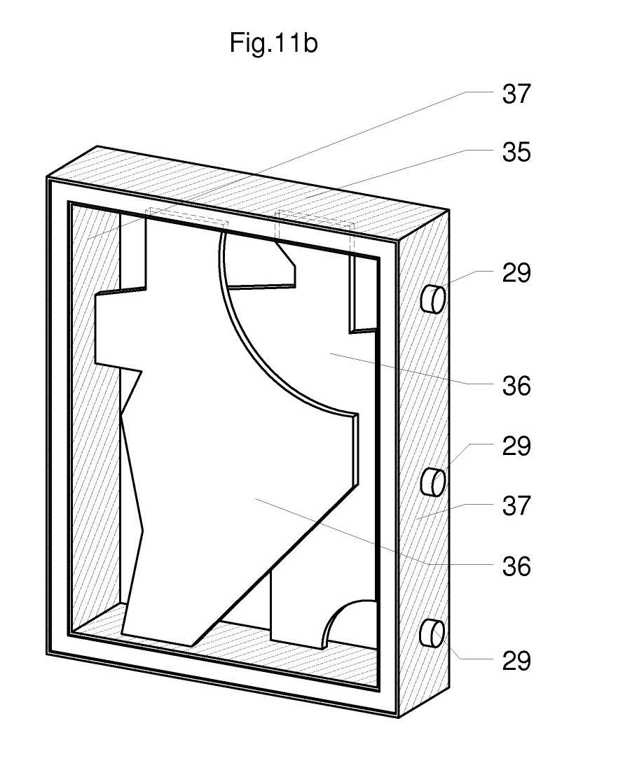

FIG. 11a shows a side view of a support panel (21) with an open frame 3-D shape (35) jutting out. The open frame (35) is affixed to the support panel (21) with stacking devices (29). The open portion of said open frame 3-D shape displays two flat-faced shapes (36) encased with magnets (29). Said open frame 3-D shape can be wood, metal, plastic or any common material used in framing.

FIG. 11b shows a perspective view of an open frame 3-D shape (35) displaying stacking devices (29) on a side. The four outer sides of the open frame 3-D shape (35) are lined with thin strips of magnet attracting metal sheets (37). The stacking devices (29) attach to the metal sheets (37). Said open frame 3-D shape has depth adequate to hold one or two or more flat-faced 3-D shapes (36). The four inner sides of said open frame 3-D shape are lined with thin strips of the magnet attracting metal sheets (37). The flat-faced 3-D shapes (36) attach to said metal sheets.

All varieties of said 3-D shapes are adaptable to placement on metal objects that attract magnets including but not limited to: furniture, mirror frames, beams, gates.

What is claimed is:

1. An art kit providing a method for the user to create a three-dimensional, artistic metal wall sculpture comprising:
a vertically hung support panel of a square, rectangular or unique shape mounted on the front facing surface with a metal sheet that attracts magnets,
a plurality of three-dimensional shapes, each with a unique outer perimeter with two or more flat-faced surfaces displaying colorful artistic images, the three-dimensional shapes encasing ferrite or neodymium or other strong magnets securely fastened to an inner side or sides and an inner edge or edges, the magnets not visible, not touchable, allowing the shape to be affixed to the support panel,
a plurality, of smaller three-dimensional metal, magnet attracting shapes without images, encasing magnets, used to stack the three-dimensional shapes and other flat shapes without encased magnets, the shapes called stacking devices,
wherein a user can move around, arrange, rearrange, interchange, reverse, stack, layer, remove or add a few or many of the three-dimensional shapes on the vertical support panel in order to create a predetermined design or an original work of art.

2. The art kit of claim 1, wherein three or more three-dimensional magnet encased shapes have perimeters that, when placed next to each other, match. Additionally, there are three or more identically shaped three-dimensional shapes, all interchangeable. Each shape can only be interchanged on the support panel in the exact place where it's matching shape has been removed. This placement method constitutes a mathematical permutation, the design changing each time one shape is removed and another identical shape replaces it displaying a different artistic image. The grouping of three-dimensional shapes can, as a whole, be reversed displaying a plurality of new, different artistic images.

3. The art kit of claim 1, wherein the perimeters of a three-dimensional shape are extended beyond the shape encasing the magnets. A simple circular shape encasing the magnets is sandwiched between the top and bottom sides of the three-dimensional shape, providing an easy method for fabricating intricately cut perimeters.

4. The art kit of claim 1, wherein one or more partial panels are positioned on the vertical support panel by means of stacking devices, the partial panels often having irregular perimeters and open spaces, constructed of sheet metal or any other material. A plurality of partial panels can be stacked to create depth.

5. The art kit of claim 1, wherein an open frame is positioned jutting out from the support panel using stacking devices, the outer sides of the frame lined with thin sheet metal that attracts magnets. The depth of the frame us adequate to allow the placement of one or more three-dimensional magnet encased shapes in the open area of the frame. The three-dimensional shapes are affixed to a lining of thin sheet metal that attracts magnets on the inner sides of the open frame. The placement of the open frame jutting out from the vertical support panel allows both the front and reverse sides of the three-dimensional shapes to be viewed.
